(19) United States
(12) Patent Application Publication
(10) Pub. No.: US 2003/0107571 A1
(43) Pub. Date: Jun. 12, 2003

(54) Method and system generating a contoured surface

(76) Inventors: Nicholas John Mulgan, Wellington (NZ); Leland Graeme McInnes, Wellington (NZ)

Correspondence Address: David E. Bruhn, DORSEY & WHITNEY LLP, Suite 1500, 50 South Sixth Street, Minneapolis, MN, 55402-1498, US

(21) Appl. No.: 10/286,617

(22) Filed: Nov. 1, 2002

Related U.S. Application Data
(63) Continuation of application No. PCT/NZ01/00072, filed on May 4, 2001.

(30) Foreign Application Priority Data
May 4, 2000 (NZ) 504333

(51) Int. Cl. G06T 17/00

(52) U.S. Cl. 345/420

(57) ABSTRACT

The invention provides a method of generating a surface to represent a finite set of data points. The method comprises the steps of calculating the value of each data in the finite set, calculating the value of additional data points which are not members of the finite set based on the distance of the additional data points from one or more neighbouring data points in the finite set, and displaying the surface by displaying representations of the values of the data points in the finite set and representations of the values of the additional data points. The invention in another form provides an associated system for generating a surface and an associated computer program for generating a surface.

### FIELD OF INVENTION

The invention relates to a method and system of generating a contoured surface.

### BACKGROUND TO INVENTION

It has become increasingly common to use graphic images to display different types of data. Such displays are easy to interpret and provide the user with an overall picture of a particular data set. One example is described in our patent specification WO 00/77682 to Compudigmn International Limited entitled “Data Visualisation System and Method” in which data values are contoured around a series of points.

It would be particularly desirable to further enhance the graphic representations displayed to a user by ensuring that the data values associated with each data point are shown correctly and that values for additional neighbouring data points are calculated and displayed in a computationally inexpensive manner.

### SUMMARY OF INVENTION

In broad terms in one form the invention comprises a method of generating a surface to represent a finite set of data points comprising the steps of calculating the value of each data point in the finite set; calculating the value of additional data points which are not members of the finite set based on the distance of the additional data points from one or more neighbouring data points in the finite set; and displaying the surface by displaying representations of the values of the data points in the finite set and representations of the values of the additional data points.

In broad terms in another form the invention comprises a system for generating a surface to represent a finite set of data points, the system comprising a memory in which is stored the value of each data point in the finite set; a value calculator programmed to calculate the value of additional data points which are not members of the finite set based on the distance of the additional data points from one or more neighbouring data points in the finite set; and a display programmed to display the surface by displaying representations of the values of the data points in the finite set and representations of the values of the additional data points.

In broad terms in another form the invention comprises a computer program for generating a surface to represent a finite set of data points, the computer program comprising a series of data point values in the finite set maintained in a memory; a value calculating component arranged to calculate the value of additional data points which are not members of the finite set based on the distance of the additional data points from one or more neighbouring data points in the finite set; and a display component arranged to display the surface by displaying representations of the values of the data points in the finite set and representations of the values of the additional data points.

### BRIEF DESCRIPTION OF THE FIGURES

Preferred forms of the method and system of generating a contoured surface will now be described with reference to the accompany figures in which:

FIG. 1 is a block diagram of the system in which one form of the invention may be implemented;

FIG. 2 is a preferred representation generated in accordance with the invention;

FIG. 3 is one view of two data points from the representation of FIG. 2;

FIG. 4 is a view of contours generated around the data points of FIG. 3;

FIG. 5 is a view of the data points of FIG. 3 following a spatial correction;

FIG. 6 is a view of contours generated around the data points of FIG. 5;

FIG. 7 is a view of contours in 3 dimensions generated around two data points; and

FIG. 8 is a view of contours generated around the two data points of FIG. 7 following spatial correction.

### DETAILED DESCRIPTION OF PREFERRED FORMS

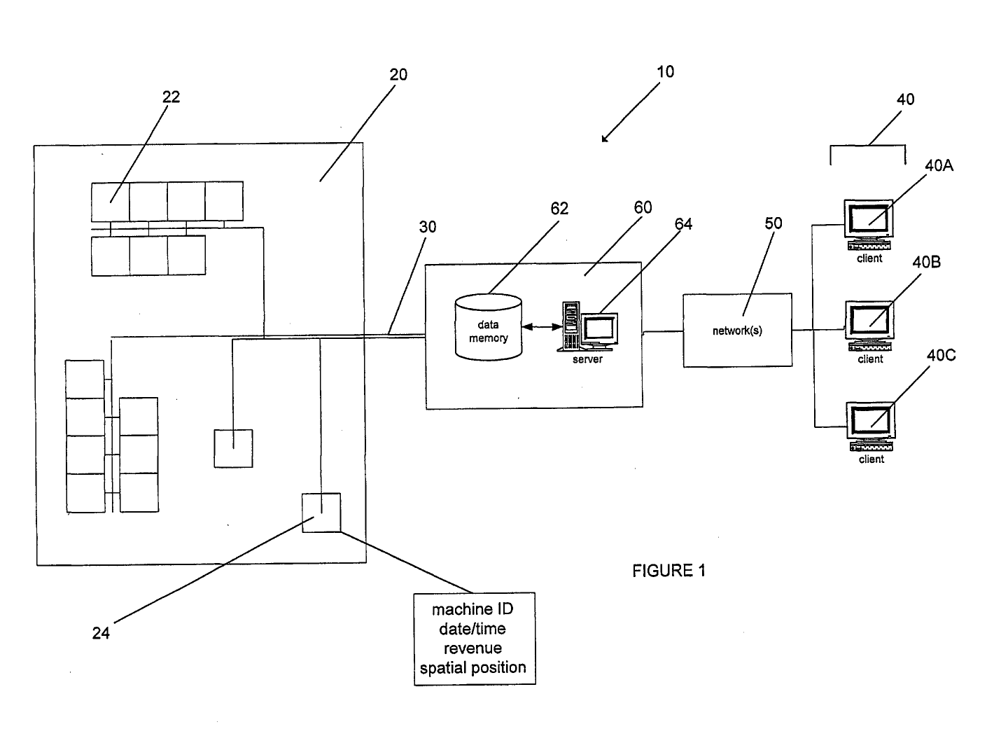

FIG. 1 illustrates a block diagram of the preferred system 10 in which one form of the present invention may be implemented. In one form the invention could be arranged to compile data from a merchant premises 20.

Typically, a merchant will operate in a commercial premises or store from which a customer purchases goods or services. The merchant may, for example, operate a petrol station in one or more geographic locations. The merchant may alternatively operate a wagering or betting service, or operate a casino or other gaming facility in which one or more gaming machines and stations are positioned in one or more rooms at a common venue.

In FIG. 1, merchant 20 operates a casino having several gaming machines available for interactions with customers in the merchant premises. Gaming machines could be grouped together in machine banks as shown with gaming machine 22 or alternatively could be positioned individually within the premises as indicated with gaming machine 24. Each of the gaming machines is preferably connected to other components of the system 10 with a suitable device such as a data bus 30, enabling data to be transferred between the machines and other parts of the system 10.

The data could be transferred in real time to other components of the system 10, could be transmitted in batches, or could be transmitted individually by polling each machine periodically. As shown in FIG. 1, the data transmitted could include a unique machine identifier, the date/time, the revenue and/or the spatial position.

The system 10 preferably includes one or more clients 40, for example 40A, 40B and 40C, which each may comprise a personal computer, workstation or other computing device. Each client 40 could be connected to other components of the network over network or networks 50. The network(s) 50 could include a local area network or LAN, wide area network or WAN, the Internet, a network based on wireless access protocol or WAP, or any combination of the foregoing. It is envisaged that these connections could be either wired or wireless. It will be appreciated that network(s) 50 could include any network infrastructure and it is envisaged that any general interconnected network is within the scope of the system 10.

The system 10 further comprises a workstation 60 or other computing device operating under the control of appropriate operating and application software having a data memory 62 connected to a server 64. The system 10 is arranged to retrieve or compile data from the merchant premises 20, process the data with the server 64 and to display the data on a client 40 using a display component such as a data display screen and associated software, as will be described below. In one form the invention comprises a computer program or collection of computer programs installed on workstation 60.

FIG. 2 illustrates data displayed by the system. A graphical representation indicated at 100 representing the nature of the data is preferably generated and displayed on client 40. The graphical representation is a representation of a casino or similar gaming venue operator comprising a spatial representation of an area of the casino showing the layout of individual gaming machines and stations, two of which are indicated at 110 and 120 respectively. It will be appreciated that the particular representation generated will be varied according to the nature of the data represented. For example, where the merchant operates from a retail store the graphical representation could include a graphical spatial representation of the store. Where a merchant operates from one or more retail stores, the graphical representation could include spatial representations of each store and could also include a large scale map of the geographical area in which the merchant stores are located.

The preferred system is arranged to present to a user on client 40 one or more key performance indicators (KPIs). These KPIs may include, for example, revenue, turnover, sales, gross profit, nett profit, gross margin return on inventory investment (GMROII), nett margin return on inventory investment (NMROII), return on nett asset (RONA), and/or loyalty sales data.

In the case of a casino operator, a typical KPI could include the revenue obtained from an individual gaming machine. The revenue or other KPI for a gaming machine is preferably graphically represented adjacent or near to the representation of the individual machine. For example, the revenue for machine 110 is graphically illustrated as data point 130 and the revenue for machine 120 is graphically illustrated as data point 140. The preferred representation is colour coded and the value of revenue of machine 110 is illustrated by representing data point 130 in the appropriate colour to represent the correct value of revenue of machine 110.

In one form each data point is represented by x and y coordinates indicating the relative position of each data point in representation 100. Each data point also has a z value representing the height or intensity of a particular data point. This z value could represent, for example, the revenue at a particular data point.

Data points 130 and 140 are members of a set of finite data points. Each (x,y) data point has an axis and a maximum value z at that axis. The invention calculates the z values of additional data points in between the finite set of data points by calculating z values of these additional data points based on the distance of these additional data points from one or more neighbouring data points from the finite set.

In one form the invention provides a computer program for generating a surface and in this form the invention comprises a value calculating component being a software implementation of a method for calculating the z values. In another form where the invention provides a system for generating a surface, the value calculator could comprise a processing device programmed to perform the fimetion of calculating the z values.

At a distance r from the axis of each finite set data point, the drop in z value is preferably calculated by multiplying the z value by the following drop-off function:

$$f ( r ) = \frac{1}{1 + ( \frac{r}{a} )} p \qquad ( 1 )$$

The value of p is preferably 2 or 3. As the value of p is increased, the data point is represented having a steeper shoulder and a flatter peak with steeper walls.

The value of a defines the horizontal distance between the axis and the point of maximum drop off of the resulting curve, which in practice defines the width of the hill. The value of a could be for example the point of “half height” of the value. Small values of a will result in fine detail in a contoured representation and larger values of a will result in a less detailed representation. Inside a retail store or casino facility the value of a could be 0.5 m whereas in a geographic map of a city a could be 500 m for example. Smaller values of a give distinct pinnacles of fine detail whereas larger values of a give lower blunter peaks which merge into each other.

Given a data point (xᵢ,yᵢ) having a KPI value zᵢ, as described above, the z value at an intermediate (x,y) position is calculated as a function of the value of zᵢ multiplied by a function of the distance between the arbitrary (x,y) co-ordinate and the data point (xᵢ,yᵢ). This relationship is expressed as follows:

F(x,y)=zᵢƒ·(\sqrt{(x−xᵢ)²+(y−yᵢ)²}) (2)

Where there are two or more data points in the finite set as shown in the representation 100, each data point is spaced a certain distance from each other data point. The distance between data points i and j for example can be defined as:

(rᵢⱼ)²=(xᵢ−xⱼ)²+(yᵢ−yⱼ)² (3)

where rᵢⱼ is the distance between points i and j.

The KPI value of each gaming machine could be represented in a 3-dimensional co-ordinate system (xᵢ, yᵢ, zᵢ) where i=1 . . . N. Each data point in the finite set can be represented by the co-ordinate (xᵢ, yᵢ) with zᵢ being the KPI value. N is the number of data points in the finite set which in this case will be the number of gaming machines for which it is intended to represent the KPI. The data points 1 to N represent a finite set of data points.

Additional data points and additional data point values can be calculated by the following equation:

F(x,y)=Σzᵢƒ(\sqrt{(x−xᵢ)²+(y−yᵢ)²}), i=1 . . . N} (4)

In some circumstances the z values located around a particular data point will interfere with the z values calculated for neighbouring data points. The extent to which one data point will interfere with another data point can be represented as mᵢⱼ, being the height of hill j at point i. The correct value of each data point is already known, for example calculated from the database, and so it is necessary to calculate a corrective value t to use instead of z to ensure that the z value at each data point is correct.

The matrix equation M*T=Z is represented as follows:

$$[ \begin{matrix}f ( {r}_{11} ) & … & f ( {r}_{1 N} ) \\ … & & … \\ f ( {r}_{N1} ) & … & f ( {r}_{NN} )\end{matrix} ] \cdot [ \begin{matrix}{t}_{1} \\ … \\ {t}_{N}\end{matrix} ] = [ \begin{matrix}{z}_{1} \\ … \\ {z}_{N}\end{matrix} ] \qquad ( 5 )$$

Matrix M is an N by N matrix having individual values Mᵢⱼ=f(rᵢⱼ). Matrix T is an N by 1 matrix of individual corrective values tᵢⱼ. Matrix Z is an N by 1 matrix of individual z values zᵢ.

The corrective tᵢ values can be obtained using the known method of solving simultaneous linear equations, an example of which is shown below. Once the corrective tᵢ values are obtained, the remaining points on the surface to be represented can be calculated from the following equation:

F(x,y)=Σ{ti*ƒ(\sqrt{(x−xᵢ)²+(y−yᵢ)²}),i=1 . . . N} (6)

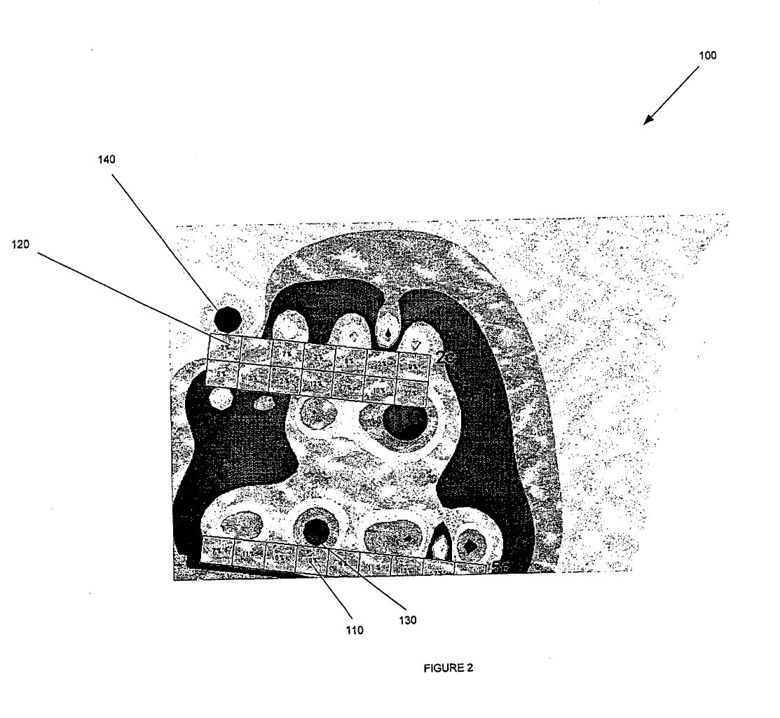

The above corrective technique is shown graphically in FIGS. 3 to 6. For the purposes of clarity, the graphs are shown in 2 dimensions rather than 3 dimensions. Referring to FIG. 3, data point 130 has a bell curve 132 below the data point showing the contour generated by the invention for data point 130, while the bell curve 142 below the data point 140 shows the contour generated by the invention for data point 140.

As described above, in some circumstances the z values located around a particular data point will interfere with z values calculated for neighbouring data points. Referring to FIG. 4, it will be apparent that the set of z values forming the contours around each of data points 130 and 140 result from summing the contour values around both points 130 and 140. As is apparent in FIG. 4, the resulting z or surface values at points 130 and 140 exceed the correct values.

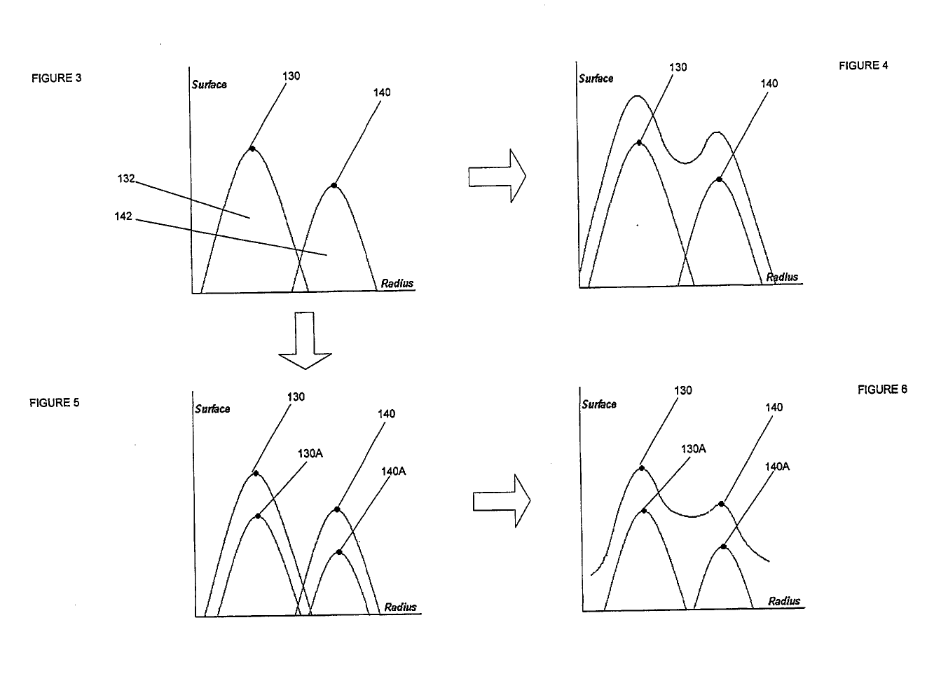

The invention substitutes the z values at data points 130 and 140 with the suitable corrective values shown in FIG. 5 as 130A and 140A respectively. Contours are then generated around revised data points 130A and 140A and, as shown in FIG. 6, the resulting contoured curve passes through data point 130 and 140.

As stated above, corrective ti values can be obtained using the known method of solving simultaneous linear equations. One data point could be P1=(p₁ₓ,p_{1y})=(1,1) and P2=(p₂ₓ,p_{2y})=(5,5). Applying equation (1) with p=2 and a=2 yields one function about P1 and another function about P2. These functions are set out as follows:

$$\begin{matrix}{F}_{1} ( x , y ) = \frac{1}{1 + ( \sqrt{{( x - {p}_{{1}_{x}} )}^{2} + {( y - {p}_{{1}_{y}} )}^{2}} ) / 4} & ( 7 ) \\ {F}_{2} ( x , y ) = \frac{1}{1 + ( \sqrt{{( x - {p}_{{2}_{x}} )}^{2} + {( y - {p}_{{2}_{y}} )}^{2}} ) / 4} & ( 8 )\end{matrix}$$

The unknowns are defined as scaling factors t₁ for point P1 and t₂ for point P2. The system to be solved is therefore:

F₁(p₁_{ₓ}, p₁_{_{y}})t₁+F₁(p₂_{ₓ}, p₂_{_{y}})t₂=1 (9)

F₂(p₂_{ₓ}, p₂_{_{y}})t₁+F₂(p₁_{ₓ}, p₁_{_{y}})t₂=1 (10)

Substituting in from equations (7) and (8) above yields:

$$\begin{matrix}\frac{1}{1 + ( \sqrt{{( {p}_{{1}_{x}} - {p}_{{1}_{x}} )}^{2} + {( {p}_{{1}_{y}} - {p}_{{1}_{y}} )}^{2}} / 4 )} {t}_{1} + \frac{1}{1 + ( \sqrt{{( {p}_{{2}_{x}} - {p}_{{1}_{x}} )}^{2} + {( {p}_{{2}_{y}} - {p}_{{1}_{y}} )}^{2}} ) / 4} {t}_{2} = 1 & ( 11 ) \\ \frac{1}{1 + ( \sqrt{{( {p}_{{1}_{x}} - {p}_{{2}_{x}} )}^{2} + {( {p}_{{1}_{y}} - {p}_{{2}_{y}} )}^{2}} / 4 )} {t}_{1} + \frac{1}{1 + ( \sqrt{{( {p}_{{2}_{x}} - {p}_{{2}_{x}} )}^{2} + {( {p}_{{2}_{y}} - {p}_{{2}_{y}} )}^{2}} / 4 )} {t}_{2} = 1 & ( 12 )\end{matrix}$$

Evaluating for P1=(p₁ₓ,p_{1y})=(1,1) yields:

t₁+0.414t₂=1 (13)

0.414t₁+t₂=1 (14)

Equations (13) and (14) can then be solved by substitution. Rearranging equation (13) yields:

t₁=1−0.414t₂ (15)

Substituting equation (5) into equation (14) yields:

0.414(1−0.414t₂)+t₂=1 (16)

[symbol]

0.414−(0.414)²t₂+t₂=1 (17)

[symbol]

(1−(0.414)²)t₂=1−0.414 (18)

$$⇒ {t}_{2} = \frac{1 - 0.414}{1 - {( 0.414 )}^{2}} = 0.707 \qquad ( 19 )$$

Back substitution gives t₁=0.707

In this way, the corrective scaling factors are calculated which can then be used to scale the values at the source points.

The invention in the form described above generates a curve or surface which passes through a number of known data points, and generates values for neighbouring additional data points. In the form described above, these data points could represent 2-dimensional (x,y) co-ordinates with an associated z value for each data point.

In another form of the invention, the data points could have 3-dimensional, 4-dimensional or further dimensional characters. In the example described above, each gaming machine has an x,y co-ordinate in a merchant premises 20, and a plan view of this merchant premises is generated and contoured. Each machine could alternatively be represented by an (x,y,z) spatial co-ordinate, particularly where gaming machines are distributed through a multi-level building. The x and y co-ordinates could represent the x and y co-ordinates on a particular floor of a building and the z co-ordinate could indicate the floor of the building on which the machine is located. This (x,y,z) co-ordinate could have a further co-ordinate associated with it, for example a KPI such as revenue.

Given a data point (xᵢ,yᵢ,zᵢ) having a KPI value kᵢ, the k value at an intermediate (x,y,z) position is calculated as a function of the product of kᵢ multiplied by a function of the distance between the arbitary (x,y,z) co-ordinate and the data point (xᵢ,yᵢ,zᵢ). This relationship is essentially a 3-dimensional extension of equation 2 and is set out below.

F(x, y, z)=kᵢ·ƒ({square root over (((x−xᵢ)²+(y−yᵢ)²+(z−zᵢ)²)}) (20)

Additional data points and additional data point values can be calculated by a 3-dimensional extension of equation 4 as set out below.

F(x, y, z)=Σkᵢf({square root over ((x−xᵢ)²+(y−yᵢ)²+(z−zᵢ)²))}), i=1 . . . N (21)

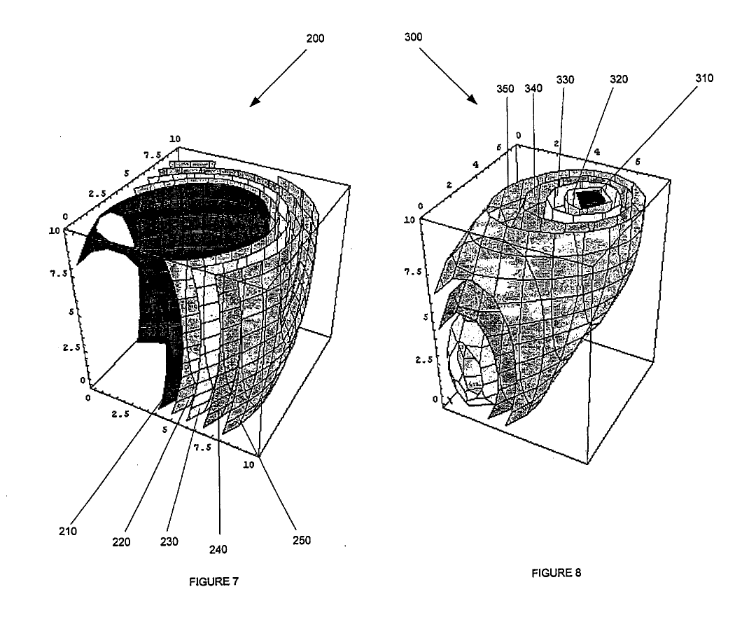

The corrective technique in 3 dimensions, known as spatial normalisation, is described with reference to FIGS. 7 and 8. FIG. 7 illustrates the initial contoured surface about 2 data points. The first data point has the spatial co-ordinates (1,1,1) and has a k value of 0.1. The second data point has the spatial co-ordinate (5,5,5) and also has a k value of 0.1. For ease of visualisation, FIG. 7 shows contours as a series of hypersurfaces around each data point.

The representation 200 as shown in FIG. 7 illustrates five contoured surfaces shown at 210, 220, 230, 240 and 250 respectively. Contour 210 represents a value of 0.09, contour 220 represents a value of 0.085, contour 230 represents a value of 0.08, contour 240 represents a value of 0.075 and contour 250 represents a value of 0.07.

As is apparent from FIG. 7, the hypersurface about each data point attains k values well above those expected at the source point positions, similar to the surface shown in FIG. 3.

Using a series of simultaneous linear equations results in the corrective scaling value of 0.732, the calculation of which is described below. Applying this scaling value to the surfaces around the two data points results in the representation 300 shown in FIG. 8 comprising contoured surfaces 310, 320, 330, 340 and 350. As is apparent from the representation 300, the spatially normalised hypersurfaces do pass through the source points (1,1,1) and (5,5,5) at the required value of 0.1.

The simultaneous, linear equations resulting in a scaling value of 0.732 are described as follows. Given two points P1=(p₁ₓ,p_{1y},p_{1z})=(1,1,1) and P2=(p₂ₓ,p_{2y},p_{2z})=(5,5,5), the functions about points P1 and P2 are respectively:

$$\begin{matrix}{F}_{1} ( x , y , z ) = \frac{1}{1 + ( \sqrt{{( x - {p}_{{1}_{x}} )}^{2} + {( y - {p}_{{1}_{y}} )}^{2} + {( z - {p}_{{1}_{z}} )}^{2}} / 4 )} & ( 22 ) \\ {F}_{2} ( x , y , z ) = \frac{1}{1 + ( \sqrt{{( x - {p}_{{2}_{x}} )}^{2} + {( y - {p}_{{2}_{y}} )}^{2} + {( z - {p}_{{2}_{z}} )}^{2}} / 4 )} & ( 23 )\end{matrix}$$

The scaling factors are defined as t₁ for point P1 and t₂ for point P2. The system requiring a solution is:

F₁(p₁_{ₓ}, p₁_{_{y}}, p₁_{_{z}})t₁+F₁(p₂_{ₓ}, p₂_{_{y}}, p₂_{_{z}})t₂=1 (24)

F₂(p₂_{ₓ}, p₂_{_{y}}, p₂_{_{z}})t₁+F₂(p₁_{ₓ}, p₁_{_{y}}, p₁_{_{z}})t₂=1 (25)

Substituting in from equations (22) and (23) yields:

$$\begin{matrix}\frac{1}{1 + ( \sqrt{{( {p}_{{1}_{x}} - {p}_{{1}_{x}} )}^{2} + {( {p}_{{1}_{y}} - {p}_{{1}_{y}} )}^{2} + ( - {p}_{{1}_{z}} - {p}_{{1}_{z}} )} / 4 )} {t}_{1} + & ( 26 ) \\ \frac{1}{1 + ( \sqrt{{( {p}_{{2}_{x}} - {p}_{{1}_{x}} )}^{2} + {( {p}_{{2}_{y}} - {p}_{{1}_{y}} )}^{2} + ( - {p}_{{2}_{z}} - {p}_{{1}_{z}} )} / 4 )} {t}_{2} = 1 & \\ \frac{1}{1 + ( \sqrt{{( {p}_{{1}_{x}} - {p}_{{2}_{x}} )}^{2} + {( {p}_{{1}_{y}} - {p}_{{2}_{y}} )}^{2} + {( {p}_{{1}_{z}} - {p}_{{2}_{z}} )}^{2}} / 4 )} {t}_{1} + \\ \frac{1}{1 + ( \sqrt{{( {p}_{{2}_{x}} - {p}_{{2}_{x}} )}^{2} + {( {p}_{{2}_{y}} - {p}_{{2}_{y}} )}^{2} + {( - {p}_{{2}_{z}} - {p}_{{2}_{z}} )}^{2}} / 4 )} {t}_{2} = 1 & ( 27 )\end{matrix}$$

Evaluating for P1=(1,1,1) and P2=(1,1,1) yields:

t₁+0.366t₂=1 (28)

0.366t₁+t₂=1 (29)

Equations (28) and (29) can be solved by substitution. Rearranging equation (28) yields:

t₁=1−0.366t₂ (30)

Substituting equation (30) into equation (29) yields:

0.366(1−0.366t₂)+t₂=1 (31)

[symbol]

0.366−(0.366)²t₂+t₂=1 (32)

[symbol]

(1−(0.366)²)t₂=1−0.336 (33)

$$⇒ {t}_{2} = \frac{1 - 0.366}{1 - {( 0.366 )}^{2}} = 0.732 \qquad ( 34 )$$

Back substitution gives t₁=0.732.

It is envisaged that the invention could also be applied to fifth and higher dimension equations. One example is where a gaming machine has a 3-dimensional (x,y,z) co-ordinate. The machine may have a revenue value k and may also have a time value t, providing a further dimension. The invention could then generate representations at particular time intervals and produce an animated sequence displaying successive representations.

It is envisaged that the invention have application in the representation of data of a varied nature. This data could include interactions between customers and merchants, but may also be used to represent any data value in a graphically intuitive way.

The invention provides a method and system of generating a curve or surface which passes through a number of known data points, and generates values for neighbouring additional data points in a computationally inexpensive manner. The curve or surface is exact at a finite set of data points, each point representing the apex of a bell shaped curve. The method and system generates contours which spread as the values of the data points increase and retreat as the values of the data points decrease. Large values result in higher contour intervals shown by tall substantial peaks.

The foregoing describes the invention including preferred forms thereof. Alterations and modifications as will be obvious to those skilled in the art are intended to be incorporated within the scope hereof, as defined by the accompanying claims.

1. A method of generating a surface to represent a finite set of data points comprising the steps of:
calculating the value of each data point in the finite set;
calculating the value of additional data points which are not members of the finite set based on the distance of the additional data points from one or more neighbouring data points in the finite set; and
displaying the surface by displaying representations of the values of the data points in the finite set and representations of the values of the additional data points.

2. A method of generating a surface as claimed in claim 1 wherein the step of calculating the value of each additional data point is based on both the value of one or more neighbouring data points in the finite set and the distance of the additional data point from the neighbouring data points.

3. A method of generating a surface as claimed in claim 1 or claim 2 wherein the step of calculating the value of the additional data points is based on both the value of each data point and the distance of the additional data points from each data point in the finite set.

4. A method of generating a surface as claimed in any one of the preceding claims wherein the step of calculating the value of the additional data points further comprises the steps of calculating a scaling factor and applying the scaling factor to the value of each data point.

5. A system for generating a surface to represent a finite set of data points, the system comprising:
a memory in which is stored the value of each data point in the finite set;
a value calculator programmed to calculate the value of additional data points which are not members of the finite set based on the distance of the additional data points from one or more neighbouring data points in the finite set; and
a display programmed to display the surface by displaying representations of the values of the data points in the finite set and representations of the values of the additional data points.

6. A system of generating a surface as claimed in claim 5 wherein the value calculator is programmed to calculate the value of each additional data point based on both the value of one or more neighbouring data points in the finite set and the distance of the additional data point from the neighbouring data points.

7. A system of generating a surface as claimed in claim 5 or claim 6 wherein the value calculator is programmed to calculate the value of the additional data points based on both the value of each data point and the distance of the additional data points from each data point in the finite set.

8. A system of generating a surface as claimed in any one of claims 5 to 7 wherein the value calculator is further programmed to calculate a scaling factor and apply the scaling factor to the value of each data point.

9. A computer program for generating a surface to represent a finite set of data points, the computer program comprising:
a series of data point values in the finite set maintained in a memory;
a value calculating component arranged to calculate the value of additional data points which are not members of the finite set based on the distance of the additional data points from one or more neighbouring data points in the finite set; and
a display component arranged to display the surface by displaying representations of the values of the data points in the finite set and representations of the values of the additional data points.

10. A computer program as claimed in claim 9 wherein the value calculating component is arranged to calculate the value of each additional data point based on both the value of one or more neighbouring data points in the finite set and the distance of the additional data point from the neighbouring data points.

11. A computer program as claimed in claim 9 or claim 10 wherein the value calculating component is arranged to calculate the value of the additional data points based on both the value of each data point and the distance of the additional data points from each data point in the finite set.

12. A computer program as claimed in any one of claims 9 to 11 wherein the value calculating component is further arranged to calculate a scaling factor and apply the scaling factor to the value of each data point.

13. A computer program as claimed in any one of claims 9 to 12 embodied on a computer-readable medium.
